(19) United States
(12) Patent Application Publication
(10) Pub. No.: US 2015/0222819 A1
(43) Pub. Date: Aug. 6, 2015

(54) IMAGING APPARATUS

(71) Applicant: SONY CORPORATION, Tokyo (JP)

(72) Inventor: KOICHI SADATSUKI, TOKYO (JP)

(21) Appl. No.: 14/604,995

(22) Filed: Jan. 26, 2015

(30) Foreign Application Priority Data
Feb. 3, 2014 (JP) 2014-018657

(51) Int. Cl. H04N 5/232; H04N 5/225

(52) U.S. Cl. CPC H04N 5/23293; H04N 5/2252; H04N 5/23245; H04N 5/23216

(57) ABSTRACT

There is provided an imaging apparatus including a first housing at one end of which an imaging lens is mounted, a second housing on which a display is mounted, and a rotating mechanism including a linking portion linking another end of the first housing and one end of the second housing. The first housing and the second housing are made mutually rotationally movable by the rotating mechanism. The first housing and the second housing are linked by the linking portion such that the one end of the first housing and another end of the second housing are capable of orienting in a same direction.

### CROSS REFERENCE TO RELATED APPLICATIONS

This application claims the benefit of Japanese Priority Patent Application JP 2014-018657 filed Feb. 3, 2014, the entire contents of which are incorporated herein by reference.

### BACKGROUND

The present technology relates to a technical field of an imaging apparatus in which a first housing on which an imaging lens is mounted and a second housing on which a display is mounted are mutually rotationally movably linked.

Among various imaging apparatuses such as camcorders and still cameras, some are configured by a first housing on which an imaging lens is mounted and a second housing on which a display is mounted being mutually rotationally movably linked (see, for example, JP 2005-189601A, JP 2013-254007A (corresponding US patent: US 2013/0321691), and JP 2006-78755A).

According to such imaging apparatuses, the direction in which the imaging lens is oriented and the direction in which the display is oriented can be made different and therefore, various shooting styles such as high-angle shots, low-angle shots, and self shots (shots by orienting both of the imaging lens and the display toward the cameraman) can be applied.

### SUMMARY

Here, improved usability such as supporting various shooting styles like, as described above, high-angle shots, low-angle shots, and self shots is desired.

The present technology is developed in view of such circumstances and there is a need for improved usability of imaging apparatuses.

First, an imaging apparatus according to an embodiment of the present disclosure includes a first housing at one end of which an imaging lens is mounted, a second housing on which a display is mounted, and a rotating mechanism including a linking portion linking another end of the first housing and one end of the second housing. The first housing and the second housing are made mutually rotationally movable by the rotating mechanism. The first housing and the second housing are linked by the linking portion such that the one end of the first housing and another end of the second housing are capable of orienting in a same direction.

Accordingly, the second housing on which the display is mounted can be caused to function as a grip portion to grip the imaging apparatus for shooting or the second housing can be caused to function as a seat portion of the first housing for stationary shooting, which increases shooting styles that can be supported.

Second, it is desirable that the imaging apparatus according to an embodiment of the present disclosure described above further includes a control unit that switches an operation mode based on a deformed state of the imaging apparatus accompanying rotation. Accordingly, an appropriate operation mode in accordance with the form of using the imaging apparatus is set.

Third, in the imaging apparatus according to an embodiment of the present disclosure described above, it is desirable that the control unit causes the display to display captured images captured via the imaging lens and images for operation separately. Accordingly, a wasteful non-display area can be prevented from arising on the display.

Fourth, in the imaging apparatus according to an embodiment of the present disclosure described above, it is desirable that the control unit causes the display to display playback images as full-screen images in a playback mode in which images are played back. Accordingly, maximally large playback images are presented.

Fifth, in the imaging apparatus according to an embodiment of the present disclosure described above, it is desirable that the display is formed on a surface of the second housing directly facing the first housing in a state in which the one end of the first housing and the another end of the second housing are oriented in the same direction, and the control unit determines whether the imaging apparatus is in a state corresponding to a stationary shooting mode as a state in which the first housing is rotated upward by a predetermined angle from a state in which the one end of the first housing and the another end of the second housing are oriented in the same direction based on the deformed state, and in accordance with a determination to be the state corresponding to the stationary shooting mode, causes captured images captured via the imaging lens on a display area on a farther side from the linking portion on the display to be displayed, and makes a display area on a closer side to the linking portion on the display a non-display area. Accordingly, captured images are displayed in the display area on the side on which images can be more easily viewed by the cameraman.

Sixth, in the imaging apparatus according to an embodiment of the present disclosure described above, it is desirable that a whole part of the display is covered with the first housing while the second housing is folded to a side of the first housing. Accordingly, the display is not exposed to surroundings in an accommodated state in which the second housing is folded to the side of the first housing.

Seventh, in the imaging apparatus according to an embodiment of the present disclosure described above, it is desirable that, when a direction from the one end to the another end of the first housing is a depth direction of the first housing, a direction perpendicular to the depth direction of the first housing is a lateral direction of the first housing, a direction from the one end to the another end of the second housing is a depth direction of the second housing, and a direction perpendicular to the depth direction of the second housing is a lateral direction of the second housing, a length in the depth direction of the first housing and a length in the depth direction of the second housing are made substantially equal, and a length in the lateral direction of the first housing and a length in the lateral direction of the second housing are made substantially equal. Accordingly, the external surface of the imaging apparatus can be formed without steps while one end of the first housing and the other end of the second housing are oriented in the same direction, that is, the second housing is accommodated.

Eighth, in the imaging apparatus according to an embodiment of the present disclosure described above, it is desirable that the first housing and the second housing are made mutually rotationally movable by the rotating mechanism in two rotating directions of different rotating axes. Accordingly, the degree of freedom of deformation of the imaging apparatus is increased.

Ninth, in the imaging apparatus according to an embodiment of the present disclosure described above, it is desirable that the linking portion links the first housing and the second housing such that a center axis of rotation is displaceable. Accordingly, there is no need to round the corner on the other end side of the second housing when the first housing and the second housing are made to be mutually rotationally movable.

Tenth, it is desirable that the imaging apparatus according to an embodiment of the present disclosure described above further includes an energizing member that energizes such that a center of the rotation is displaced in a predetermined direction. Accordingly, the displaced center of rotation is brought back to its original position by the energizing member.

According to the present technology, usability of imaging apparatuses can be improved.

Effects described here are not necessarily to be limited and any effect described in the present disclosure may apply.

### BRIEF DESCRIPTION OF THE DRAWINGS

FIG. 1 is a front view of an imaging apparatus according to an embodiment;

FIG. 2 is a rear view of the imaging apparatus according to an embodiment;

FIG. 3 is a right side view of the imaging apparatus according to an embodiment;

FIG. 4 is a left side view of the imaging apparatus according to an embodiment;

FIG. 5 is a top view of the imaging apparatus according to an embodiment;

FIG. 6 is a bottom view of the imaging apparatus according to an embodiment;

FIG. 7 is a perspective view of the imaging apparatus according to an embodiment;

FIG. 8 is a perspective view of the imaging apparatus according to an embodiment;

FIG. 9 is a rear view of the imaging apparatus showing by seeing through a rotating axis portion included in a linking portion;

FIG. 10 is a bottom view of the imaging apparatus showing by seeing through the rotating axis portion included in the linking portion;

FIG. 11 is an A-A′ sectional view when the imaging apparatus is cut along an A-A′ surface shown in FIG. 10;

FIG. 12 is a B-B′ sectional view when the imaging apparatus is cut along a B-B′ surface shown in FIG. 10;

FIG. 13 is a diagram showing a state in which the rotating axis portion is pushed down simultaneously with a second housing being pushed down by a B-B′ sectional view;

FIGS. 14A and 14B are each an explanatory view showing the reason for making a rotation center displaceable;

FIG. 15 is a diagram showing another example of a rotating mechanism by the A-A′ sectional view similar to that in FIG. 11;

FIG. 16 is a diagram showing another example of the rotating mechanism by the B-B′ sectional view similar to that in FIG. 12;

FIG. 17 is a diagram showing another example of the rotating mechanism in a state after the rotation center being displaced from the state of FIG. 16 by the B-B′ sectional view similar to that in FIG. 12;

FIG. 18 is a perspective view of the imaging apparatus in a displaced state corresponding to a normal shooting mode;

FIG. 19 is a perspective view of the imaging apparatus in the displaced state corresponding to stationary shooting;

FIG. 20 is a perspective view of the imaging apparatus in the displaced state corresponding to a self shot shooting mode;

FIG. 21 is a perspective view of the imaging apparatus in the displaced state corresponding to a still image portrait shooting mode;

FIG. 22 is a perspective view of the imaging apparatus in the displaced state corresponding to a playback mode;

FIG. 23 is a block diagram showing a circuit configuration inside the imaging apparatus;

FIG. 24 is a flow chart showing processing performed by the imaging apparatus; and

FIG. 25 is an explanatory view of a display area of a display.

### DETAILED DESCRIPTION OF THE EMBODIMENT(S)

An embodiment will be described below in the order shown below:

### <1. Appearance/Structure of Imaging Apparatus>

### <2. Operation Mode>

### <3. Internal Configuration of Imaging Apparatus>

<4. Processing in Accordance with Operation Mode>

### <5. Summary of Embodiment>

### <6. Modification>

### <7. Present Technology>

<1. Appearance/Structure of Imaging Apparatus>

An imaging apparatus 1 as an embodiment of the present technology will be described below with reference to the appended drawings.

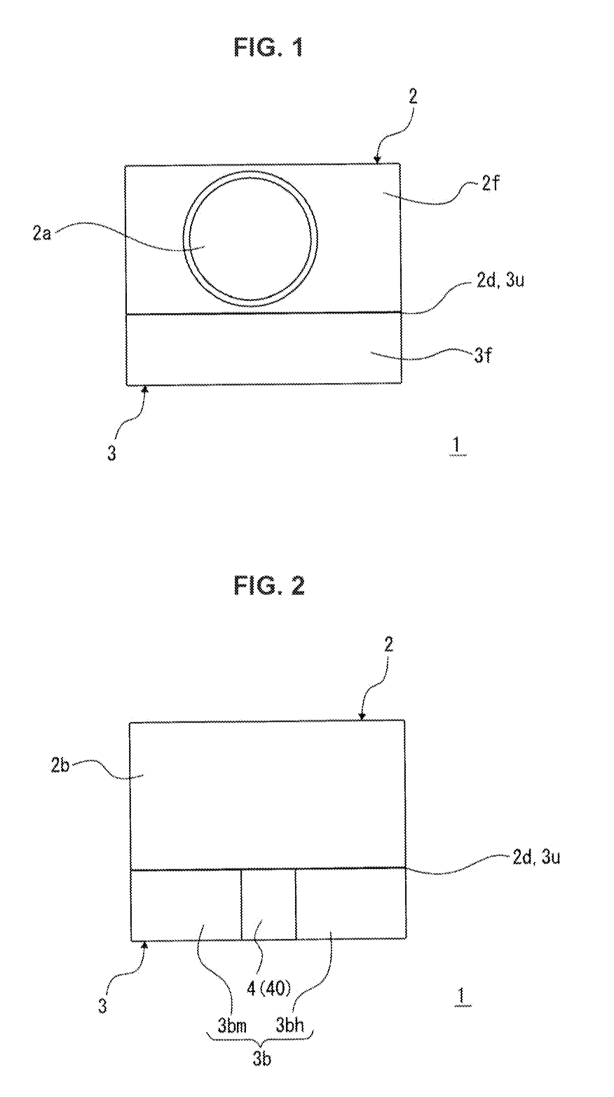

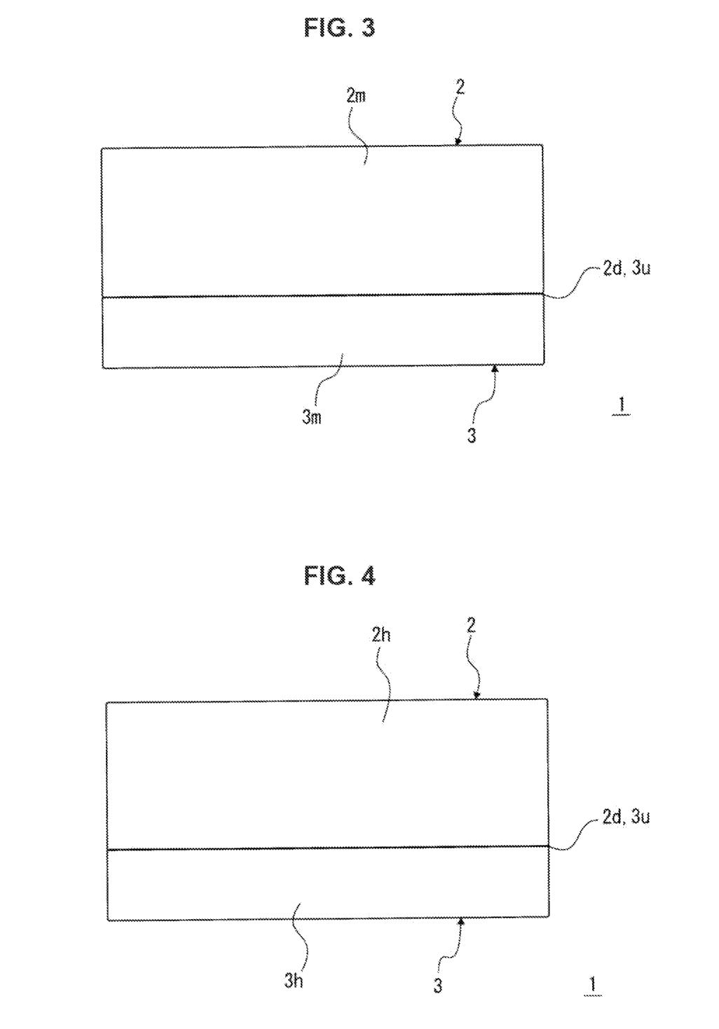

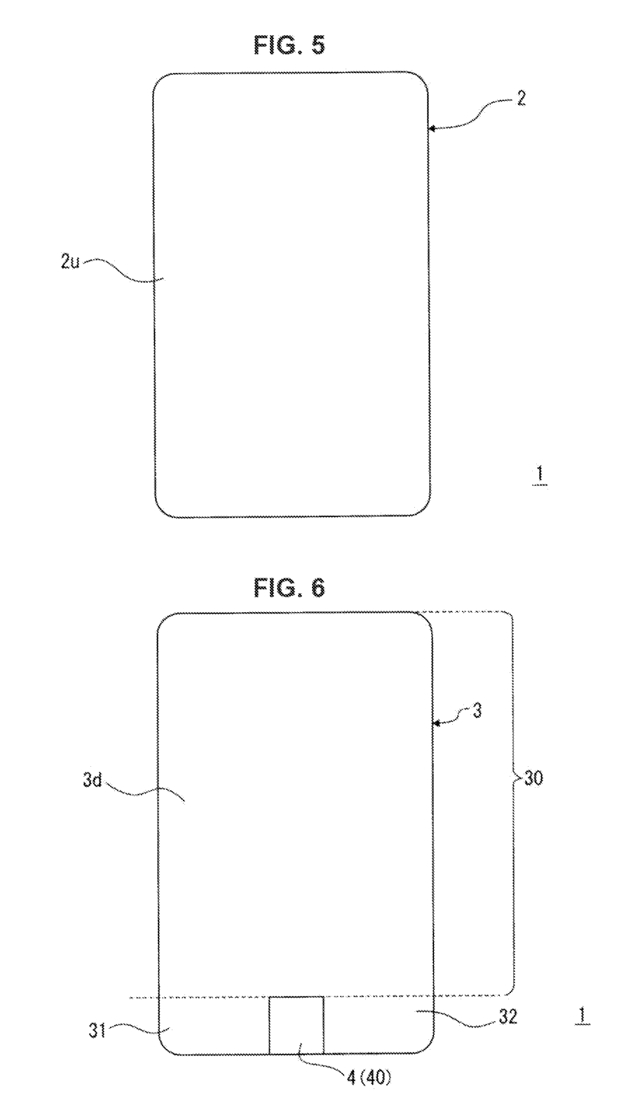

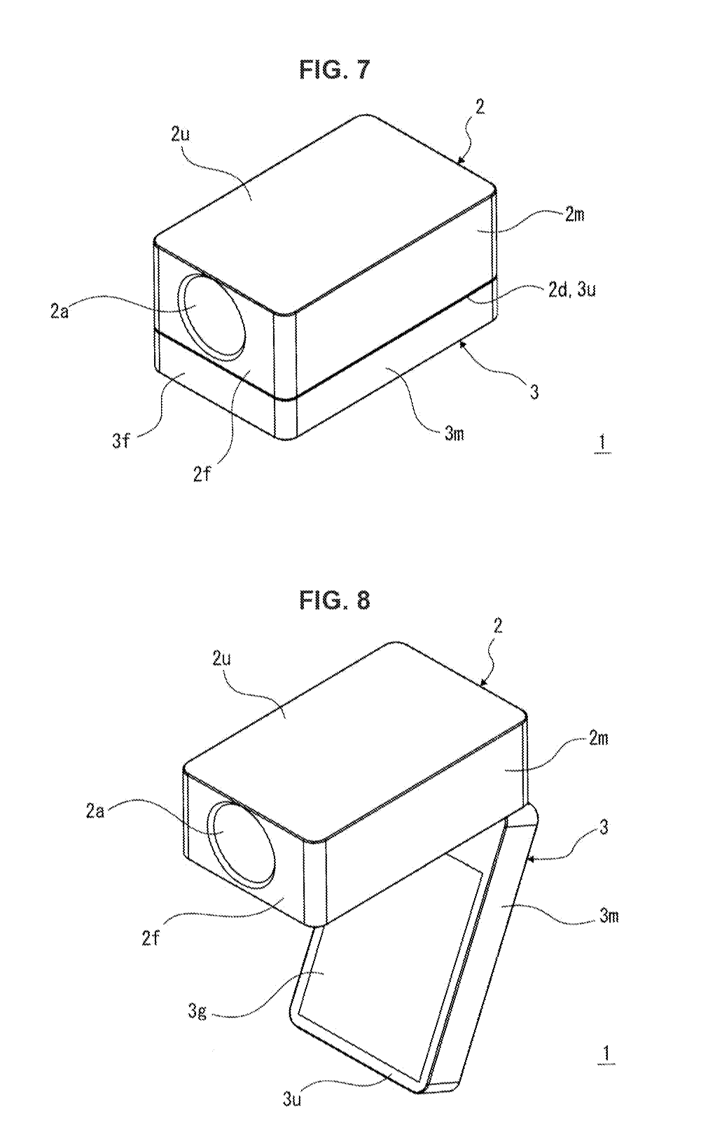

FIGS. 1 to 6 are a front view, a rear view, a right side view, a left side view, a top view, and a bottom view of the imaging apparatus 1 respectively and FIGS. 7 and 8 are perspective views of the imaging apparatus 1.

The imaging apparatus 1 includes a first housing 2 at one end of which an imaging lens 2a is mounted on and a second housing 3 on which a display 3g (see FIG. 8) is mounted. The first housing 2 and the second housing 3 are made mutually rotationally movable by a rotating mechanism (described later) including a linking portion 4 linking the other end of the first housing 2 and one end of the second housing 3.

As will be clear from the description that follows, only a body portion 40 of the linking portion 4 is exposed to surroundings and this fact is indicated by parenthesized reference numeral “40” shown in FIGS. 2 and 6.

“One end” and “the other end” of the first housing 2 and the second housing 3 will be put in order here. “One end” of the first housing 2 means, as described above, an end on the side on which the imaging lens 2a is mounted and “the other end” of the first housing 2 is an end on the opposite side of the “one end” and an end on the side linked to one end of the second housing 3 by the linking portion 4.

“One end” of the second housing 3 is an end on the side linked to “the other end” of the first housing 2 by the linking portion 4 and “the other end” of the second housing 3 is an end on the opposite side of the “one end” of the second housing 3.

In the present example, the first housing 2 is formed in a substantially rectangular parallelopiped shape and has six surfaces, a front surface 2f, a back surface 2b, a right-side surface 2m, a left-side surface 2h, a top surface 2u, and a bottom surface 2d.

The front surface 2f of the first housing 2 is the surface on which the imaging lens 2a is mounted and the back surface 2b is the surface positioned on the opposite side of the front surface 2f. The bottom surface 2d is the surface on the side on which the second housing 3 is linked by the linking portion 4 and the top surface 2u is the surface on the opposite side of the bottom surface 2d. The right-side surface 2m is, as shown in FIGS. 1 to 7, the surface positioned on the right side of the front surface 2f when the top surface 2u is oriented upward and the left-side surface 2h is the surface positioned on the left side of the front surface 2f in the same state (surface on the opposite side of the right-side surface 2m).

The second housing 3 has, based on a substantially rectangular parallelopiped shape, a shape formed by hollowing out a center portion of “one end” (end on the side linked by the linking portion 4) in a concave shape to secure a space in which the body portion 40 of the linking portion 4 is arranged and has seven surfaces, a front surface 3f, a right-side back surface 3bm, a left-side back surface 3bh, a right-side surface 3m, a left-side surface 3h, a top surface 3u, and a bottom surface 3d. Hereinafter, when the right-side back surface 3bm and the left-side back surface 3bh in the second housing 3 are generically called, the generic name “back surface 3b” will be used.

FIGS. 1 to 7 show the imaging apparatus 1 in a state in which “one end” of the first housing 2 and “the other end” of the second housing 3 are oriented in the same direction and first housing 2 covers the display 3g in the second housing 3 (Hereinafter, this state will be called a state “accommodating” the second housing 3).

The above name of each surface of the second housing 3 is defined based on the above state in which the second housing 3 is accommodated. More specifically, while the second housing 3 is accommodated, the top surface 3u is the surface in contact with (surface directly facing) the bottom surface 2d of the first housing 2 and the bottom surface 3d is the surface on the opposite side of the top surface 3u. Also while the second housing 3 is accommodated, the front surface 3f is the surface oriented in the same direction as the front surface 2f of the first housing 2 and the back surface 3b is the surface on the opposite side of the front surface 3f. Further, while the top surface 3u is oriented upward, the right-side surface 3m is the surface positioned on the right side of the front surface 3f and the left-side surface 3h is the surface positioned on the left side of the front surface 3f (surface on the opposite side of the right-side surface 3m) in the same state.

The right-side back surface 3bm and the left-side back surface 3bh are the back surface 3b on the right side and the left side when viewed in the front view respectively.

In the second housing 3, heights positioned on both sides of a border as a hollowed portion as described above are called a right-side back height 31 and a left-side back height 32 (see FIG. 6). Also in the case, the right side/left side is based on a case when viewed in the front view.

A portion obtained by excluding the right-side back height 31 and the left-side back height 32 from the second housing 3 will be called a body portion 30.

FIG. 8 shows the imaging apparatus 1 in a state after the second housing 3 being rotationally moved downward from the accommodated state shown in FIGS. 1 to 7. As shown in this figure, the display 3g is mounted on the top surface 3u of the second housing 3. A touch panel is formed in the display 3g and the cameraman is enabled to do various operational inputs into the imaging apparatus 1 through a touch operation.

If the length from the front surface 2f of the first housing 2 to the back surface 2b in the imaging apparatus 1 is defined as the depth direction length and the length from the right-side surface 2m to the left-side surface 2h is defined as the lateral direction length, the first housing 2 in the present example has the depth direction length set longer than the lateral direction length.

Also, if the length from the front surface 3f of the second housing 3 to the back surface 3b is defined as the depth direction length and the length from the right-side surface 3m to the left-side surface 3h is defined as the lateral direction length, also the second housing 3 has the depth direction length set longer than the lateral direction length.

Further in the present example, the first housing 2 and the second housing 3 have substantially the same depth direction length and lateral direction length.

Accordingly, the external surface of the imaging apparatus 1 can be formed without steps while the second housing 3 is accommodated.

In the present embodiment, while the body portion 40 of the linking portion 4 is just fitted into the aforementioned hollowed portion in a concave shape in the second housing 3, a portion obtained by combining the second housing 3 and the body portion 40 has a substantially rectangular parallelopiped shape. By making the depth direction length and the lateral direction length of the substantially rectangular parallelopiped substantially equal to the depth direction length and the lateral direction length of the first housing 2 respectively, the external surface of the imaging apparatus 1 is formed without steps when the second housing 3 is accommodated.

Incidentally, the depth direction of the first housing 2 can be put as a direction from “one end” to “the other end” of the first housing 2 and the lateral direction of the first housing 2 can be put as a direction perpendicular to the depth direction of the first housing 2.

Similarly, the depth direction of the second housing 3 can be put as a direction from “one end” to “the other end” of the second housing 3 and the lateral direction of the second housing 3 can be put as a direction perpendicular to the depth direction of the second housing 3.

The display 3g is formed in a substantially rectangular parallelopiped shape and mounted on the top surface 3u such that the long side of the display is substantially parallel to the depth direction of the second housing 3 and the short side of the housing is substantially parallel to the lateral direction of the second housing 3.

In other words, the display 3g is mounted such that the long side of the display is substantially parallel to the direction from “one end” to “the other end” of the second housing 3.

The linking portion 4 is arranged such that the body portion 40 is positioned in the portion hollowed out in a concave shape in the second housing 3, in other words, in a space between the right-side back height 31 and the left-side back height 32. In the present example, the body portion 40 is set to the shape and size just fitted into the space between the right-side back height 31 and the left-side back height 32.

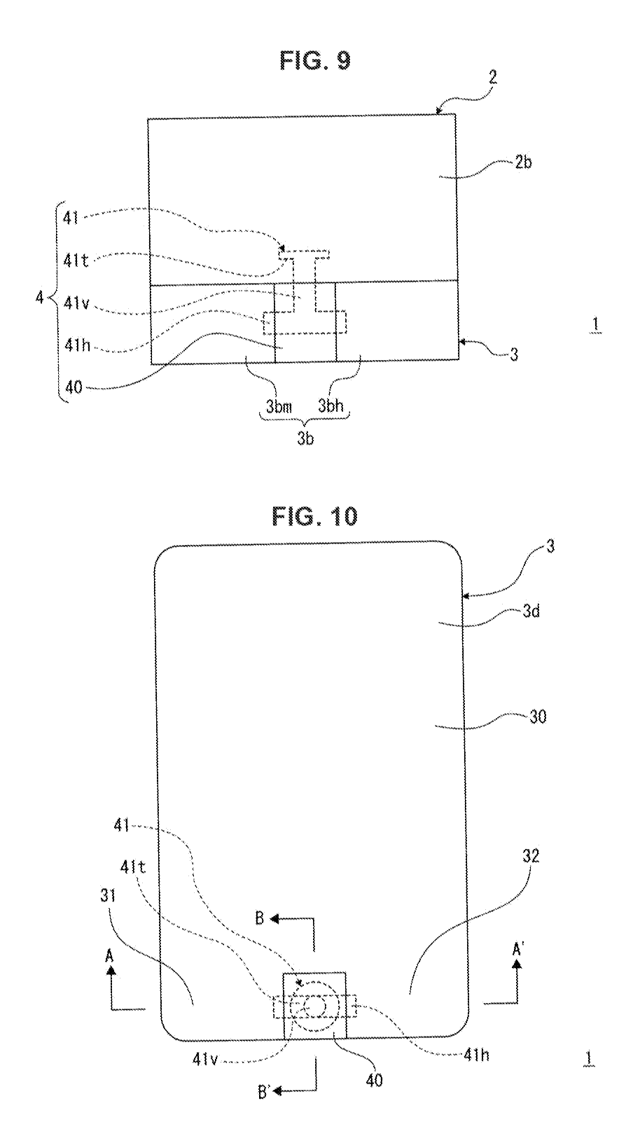

Referring to FIGS. 9 to 12, the structure of a rotating mechanism that allows the first housing 2 and the second housing 3 to mutually rotationally move by including the linking portion 4.

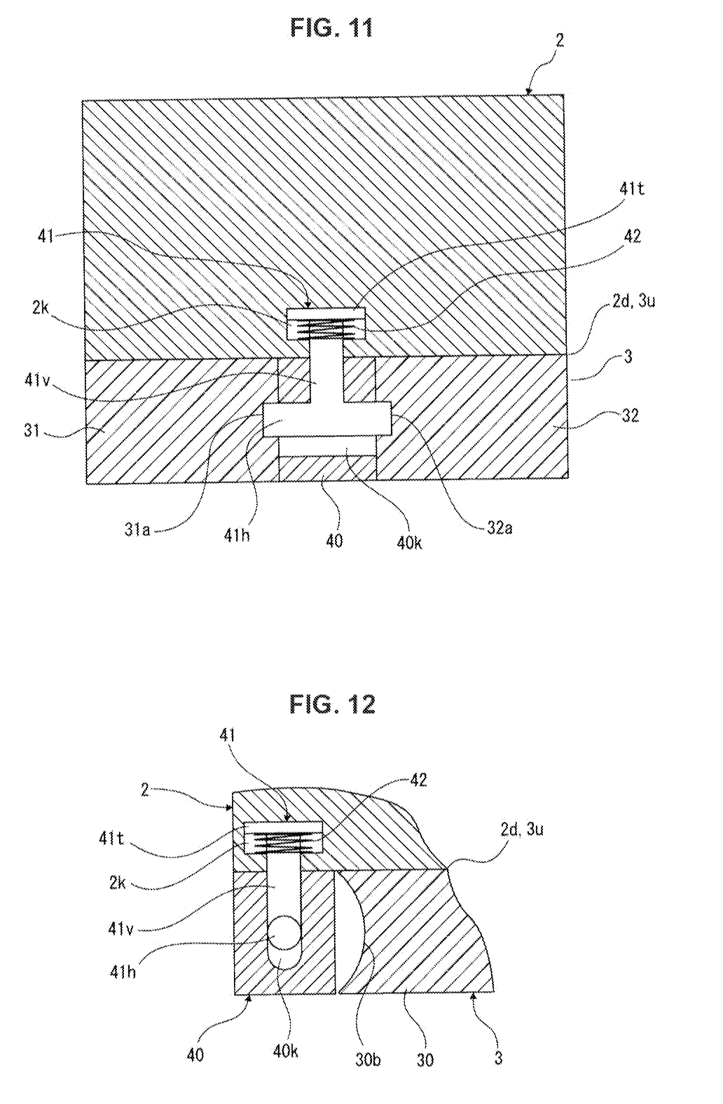

FIG. 9 is a rear view of the imaging apparatus 1 and FIG. 10 is a bottom view of the imaging apparatus 1 and each of both figures sees through a rotating axis portion 41 included in the linking portion 4. FIG. 11 is an A-A′ sectional view when the imaging apparatus 1 is cut along an A-A′ surface shown in FIG. 10 and FIG. 12 is a B-B′ sectional view when the imaging apparatus 1 is cut along a B-B′ surface shown in FIG. 10.

The linking portion 4 includes at least the rotating axis portion 41 together with the above body portion 40.

The rotating axis portion 41 includes a vertical axis portion 41v extending in the longitudinal direction, a horizontal axis portion 41h extending in the lateral direction and to the central portion of which the bottom end of the vertical axis portion 41v is connected, and a flange portion 41t in a substantially disc shape to the central portion at the bottom of which the top end of the vertical axis portion 41v is connected.

In the linking portion 4, the flange portion 41t of the rotating axis portion 41, a top end portion of the vertical axis portion 41v, and left and right end portions of the horizontal axis portion 41h project out of the body portion 40.

As shown in FIGS. 11 and 12, a space 2k in a substantially T shape is formed inside the first housing 2. The space 2k is formed by connecting a space in a substantially cylindrical shape passing through the bottom surface 2d and extending in the longitudinal direction and a space in a substantially disc shape positioned in the upper position of the space extending in the longitudinal direction. In the space 2k, the flange portion 41t and the top end portion of the vertical axis portion 41v projecting out of the body portion 40 as described above are arranged.

In this case, the flange portion 41t and the top end portion of the vertical axis portion 41v are arranged inside the space 2k such that the first housing 2 is made rotationally movable around the vertical axis portion 41v as a rotating axis.

In the present example, an energizing member 42 by, for example, a compression coil spring or a plate spring supporting the bottom of the flange portion 41t is provided inside the space 2k. The rotating axis portion 41 is energized upward by the energizing member 42.

A space 40k in a substantially inverted T shape (shape obtained by vertically inverting T) is formed inside the body portion 40. The space 40k is formed by connecting a space in a substantially cylindrical shape passing through the top surface 3u and extending in the longitudinal direction and a space in a tubular shape positioned in the lower position of the space extending in the longitudinal direction and extending in the lateral direction. In this space 40k, portions of the rotating axis portion 41 that do not project out of the body portion 40 are arranged.

A right-side fitting groove 31a and a left-side fitting groove 32a in a substantially cylindrical shape are formed in a direction opposite to the body portion 40 in the right-side back height 31 and the left-side back height 32 of the second housing 3 respectively. One end of a horizontal axis portion 41h projecting out of the body portion 40 is fitted into the right-side fitting groove 31a and the other end of the horizontal axis portion 41h similarly projecting out of the body portion 40 is fitted into the left-side fitting groove 32a.

The fitting in this case is relatively loose to allow the second housing 3 to rotationally move around the horizontal axis portion 41h as a rotating axis.

While the one end and the other end of the horizontal axis portion 41h are fitted into the right-side fitting groove 31a and the left-side fitting groove 32a respectively and the bottom surface 2d of the first housing 2 and the top surface 3u of the second housing 3 are in contact (state shown in FIGS. 11 and 12), a space allowing the flange portion 41t to be displaced downward is secured in the space 2k and a space allowing portions of the horizontal axis portion 41h that do not project out of the body portion 40 to be displaced downward is secured in the space 40k.

That is, a space to allow the rotating axis portion 41 to be pushed down against an energizing force of the energizing member 42 is secured in each of the space 2k and the space 40k.

At this point, the rotating axis portion 41 is linked to the second housing 3 by the ends of the horizontal axis portion 41h being fitted to the right-side fitting groove 31a and the left-side fitting groove 32a and therefore, the rotating axis portion 41 is pushed down simultaneously with the second housing 3 being pushed down.

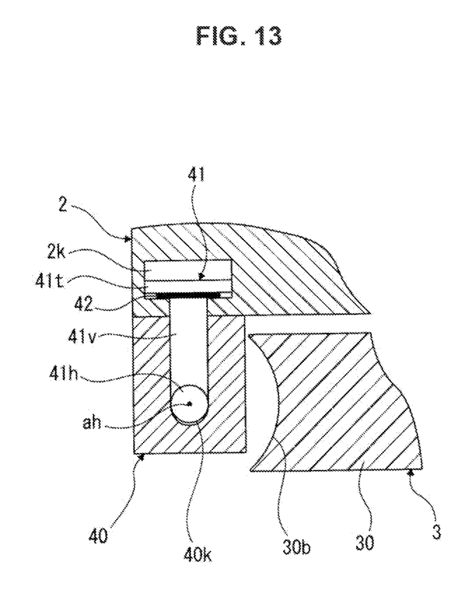

FIG. 13 shows a state in which the rotating axis portion 41 is pushed down simultaneously with the second housing 3 being pushed down by a B-B′ sectional view. That the rotating axis portion 41 is pushed down is synonymous with a downward displacement of a center ah of the horizontal axis portion 41h, that is, the position of the rotation center ah in a direction around the horizontal axis. The reason for making the rotation center ah displaceable will be described again.

If the surface of the body portion 30 opposite to the body portion 40 of the linking portion 4 in the second housing 3 is a back surface 30b, the back surface 30b is formed, as shown in FIG. 12, as a convex curved surface in a direction moving away from the body portion 40 (direction on the side of the front surface 3f).

With the above structure, the first housing 2 and the second housing 3 are made mutually rotationally movable in a direction around the vertical axis using the vertical axis portion 41v as the rotating axis and in a direction around the horizontal axis using the horizontal axis portion 41h as the rotating axis.

In addition, like the accommodated state shown in FIGS. 1 to 7, “one end” (end on the side on which the imaging lens 2a is mounted) of the first housing 2 and “the other end” (end on the opposite side of the side linked by the linking portion 4) of the second housing 3 can be made to be oriented in the same direction by the linking portion 4 described above.

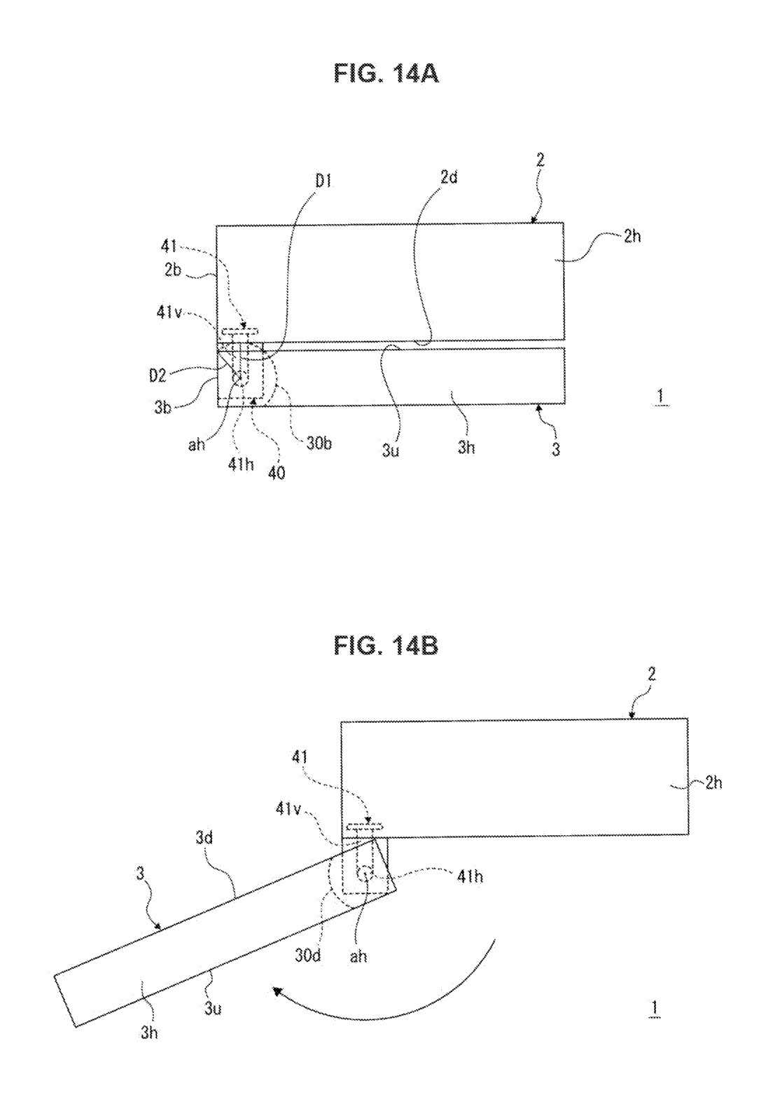

FIGS. 14A and 14B are each an explanatory view showing the reason for making the rotation center ah displaceable and FIG. 14A shows the imaging apparatus 1 in respective left side views a state in which the second housing 3 is pushed down from the accommodated state and FIG. 14B shows the imaging apparatus 1 in a state in which the second housing 3 is rotationally moved in an opening direction around the horizontal axis from the state of FIG. 14A.

As is evident by referring to FIG. 14A, by making the rotation center ah displaceable, a space through which the corner of the second housing 3 on the back surface 3b side passes with the rotation of the second housing 3 can be secured between the first housing 2 and the second housing 3. More specifically, a space through which the corner on the border between the back surface 3b and the top surface 3u of the second housing 3 (or the corner on the border between the back surface 3b and the bottom surface 3d) passes can be secured between the first housing 2 and the second housing 3.

Thus, a space through which the corner of the second housing 3 on the back surface 3b side (in other words, the corner on the “one end” side of the second housing 3) passes with the rotation of the second housing 3 can be secured between the first housing 2 and the second housing 3 and therefore, there is no need to round the corner for making the first housing 2 and the second housing 3 mutually rotationally movable.

The corner on the border between the back surface 3b and the bottom surface 3d is also taken into consideration above because there may be a case when the bottom surface 3d of the second housing 3 comes into contact with the bottom surface 2d of the first housing 2 like in a deformed state in playback mode described later depending on the rotating mechanism enabled also to rotate in a direction around the vertical axis like in the present embodiment.

To eliminate the need to round the corner as described above, the displaceable range of the rotation center ah may be set such that the shortest distance from the rotation center ah to the top surface 3u indicated as “D1” in FIG. 14A is equal to or more than the shortest distance from the rotation center ah to the corner on the border between the back surface 3b and the top surface 3u indicated as “D2” (shortest distance from the rotation center ah to the corner on the border between the back surface 3b and the bottom surface 3d).

Incidentally, there is no need to, as shown in FIG. 14A, push down the second housing 3 once to rotationally move the second housing 3 in an opening direction as shown in FIG. 14B from a state in which the bottom surface 2d of the first housing 2 and the top surface 3u or the bottom surface 3d of the second housing 3 are in contact. Even if the second housing 3 is rotationally moved in an arrow direction shown in FIG. 14B while the bottom surface 2d and the top surface 3u or the bottom surface 3d are in contact, the rotation center ah is displaced downward while the corner on the border between the back surface 3b and the top surface 3u slides accordingly on the bottom surface 2d of the first housing 2 and therefore, the second housing 3 can be rotationally moved without the corner particularly hindering the rotation.

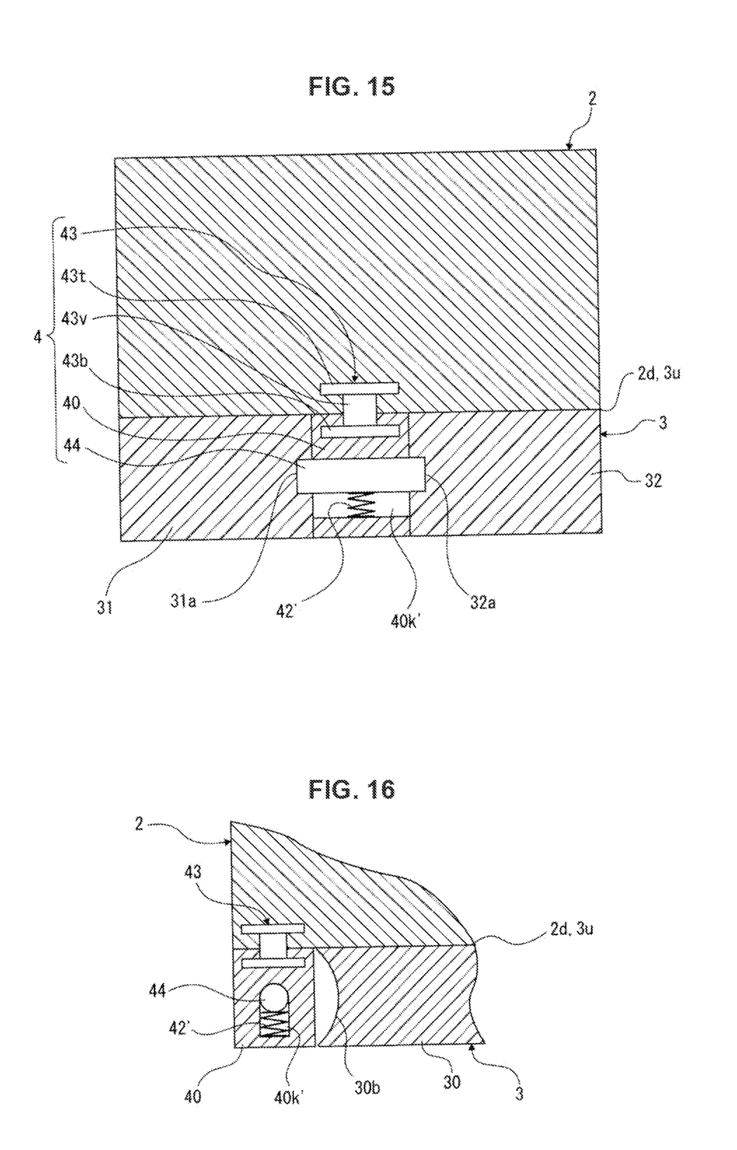

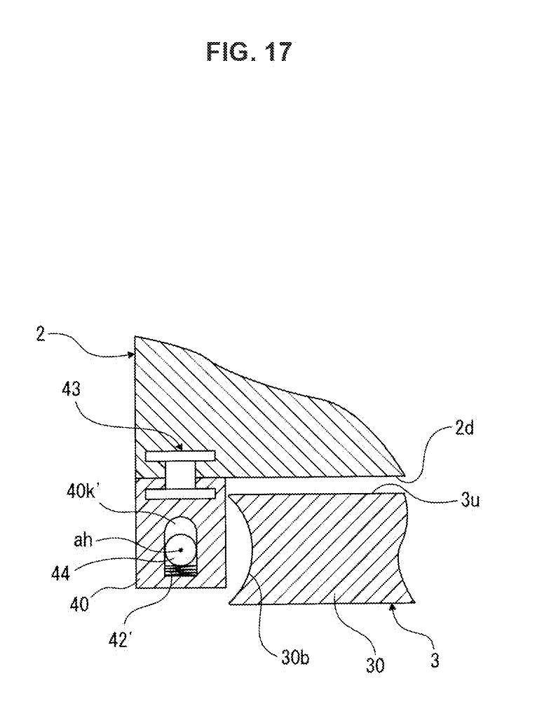

FIGS. 15 to 17 are explanatory views of another example of the rotating mechanism and FIG. 15 is, like FIG. 11, an A-A′ sectional view and FIGS. 16 and 17 are, like FIG. 12, B-B′ sectional views. Incidentally, FIG. 16 shows a state in which the bottom surface 2d of the first housing 2 and the top surface 3u of the second housing are in contact and FIG. 17 shows a state in which the bottom surface 2d and the top surface 3u are separated from each other.

In the rotating mechanism in this case, the linking portion 4 includes at least the body portion 40, a vertical axis portion 43, and a horizontal axis portion 44. As shown in these figures, the vertical axis portion 43 and the horizontal axis portion 44 are not connected and are formed as separate bodies.

The vertical axis portion 43 includes an axis portion 43v extending in the longitudinal direction, a flange portion 43t in a substantially disc shape connected to the top end side of the axis portion 43v, and a flange portion 43b in a substantially disc shape connected to the bottom end side of the axis portion 43v and is formed in a substantially I shape.

In the vertical axis portion 43, the upper-side flange portion 43t and a portion on the upper side of the axis portion 43v are fitted inside the first housing 2 and the lower-side flange portion 43b and a portion of the remaining axis portion 43v are fitted inside the body portion 40 of the linking portion 4.

In the present example, the fitting of the upper-side flange portion 43t and a portion on the upper side of the axis portion 43v and the first housing 2 is relatively loose to allow the first housing 2 to rotationally move with respect to the vertical axis portion 43 and the fitting of the lower-side flange portion 43b and a portion of the remaining axis portion 43v and the body portion 40 is such that the first housing 2 is unable to rotationally move with respect to the vertical axis portion 43. More specifically, the lower-side flange portion 43b and a portion of the remaining axis portion 43v are fixed to the body portion 40.

Accordingly, the first housing 2 is linked to the body portion 40 so as to be rotatable in a direction around the vertical axis portion 43.

Both ends of the horizontal axis portion 44 project out of the body portion 40 and one end is fitted into the right-side fitting groove 31a formed in the right-side back height 31 and the other end is fitted into the left-side fitting groove 32a formed in the left-side back height 32.

Also in this case, the fitting is relatively loose to allow the second housing 3 to rotationally move around the horizontal axis portion 44.

The body portion 40 in this case has a space 40k′ in a tubular shape extending in the lateral direction formed therein and portions in the horizontal axis portion 44 that do not project from the body portion 40 are positioned inside the space 40k′.

Inside the space 40k′, an energizing member 42′ (for example, a compression coil spring or a plate spring) that supports the horizontal axis portion 44 from below is provided. The horizontal axis portion 44 is energized upward by the energizing member 42′.

When, as described above, the one and the other ends of the horizontal axis portion 44 are fitted into the right-side fitting groove 31a and the left-side fitting groove 32a respectively and the bottom surface 2d of the first housing 2 and the top surface 3u of the second housing 3 are in contact (state shown in FIGS. 15 and 16), a space allowing the horizontal axis portion 44 to be displaced downward is secured in the space 40k′ and the center (rotation center ah) of the horizontal axis portion 44 is thereby enabled to be displaced simultaneously with motion of the second housing 3 (see FIG. 17).

Also with the rotating mechanism as the other example described above, the first housing 2 and the second housing 3 are made mutually rotationally movable in a direction around the vertical axis using the vertical axis portion 43 as the rotating axis and in a direction around the horizontal axis using the horizontal axis portion 44 as the rotating axis.

In addition, like the accommodated state shown in FIGS. 1 to 7, “one end” of the first housing 2 and “the other end” of the second housing 3 can be made to be oriented in the same direction by the linking portion 4 described above.

Further, by making the rotation center ah displaceable, also in this case, there is no need to round the corner on the border between the back surface 3b and the top surface 3u of the second housing 3 or the corner on the border between the back surface 3b and the bottom surface 3d (corner on the “one end” side of the second housing 3) to make the first housing 2 and the second housing 3 mutually rotationally movable.

<2. Operation Mode>

A plurality of operation modes is prepared for the imaging apparatus 1 according to the present embodiment.

Operation modes are roughly divided into a shooting mode for shooting and a playback mode for playing back images.

The shooting mode includes a shooting mode corresponding to landscape shooting and a shooting mode corresponding to portrait shooting.

The mode corresponding to the landscape shooting includes a normal shooting mode, a stationary shooting mode, and a self shot shooting mode.

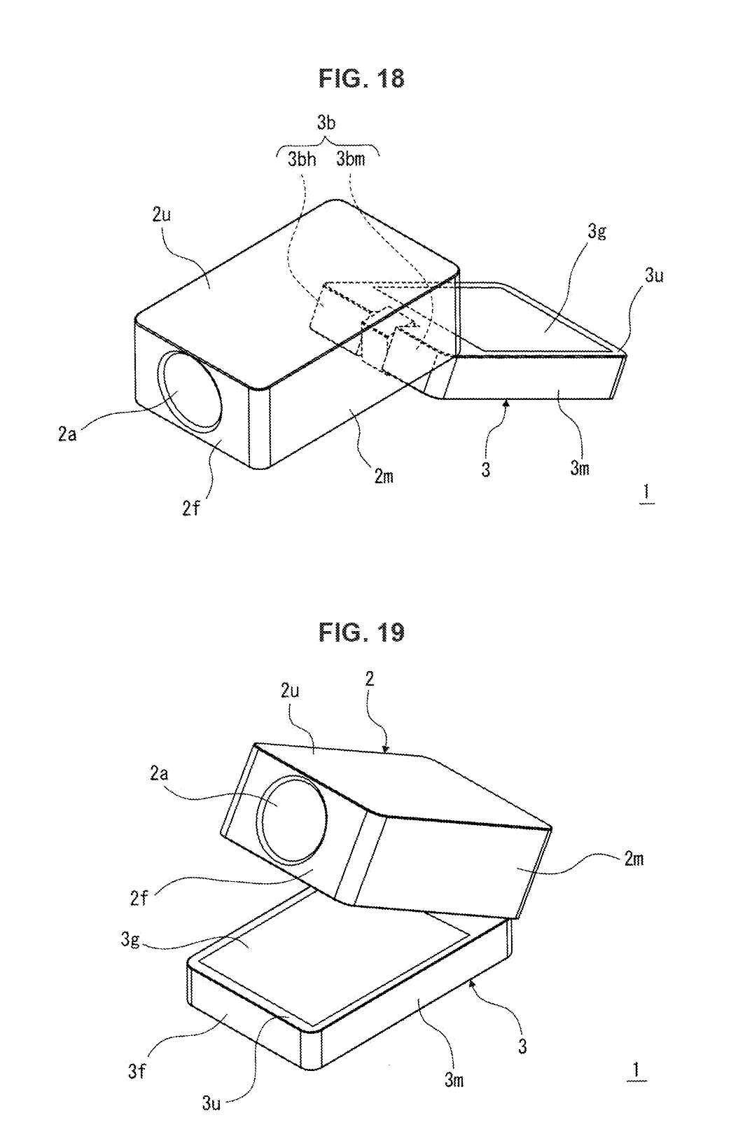

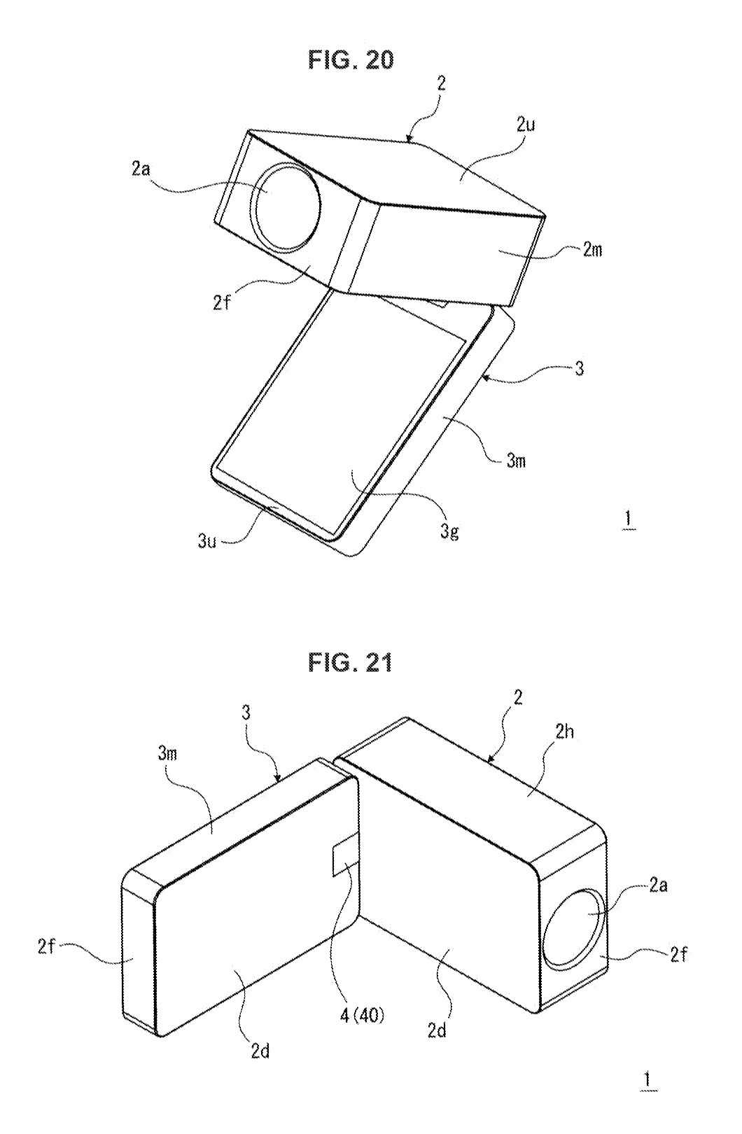

FIG. 18 shows a deformed state of the imaging apparatus 1 corresponding to the normal shooting mode, FIG. 19 shows a deformed state corresponding to the stationary shooting mode, and FIG. 20 shows a deformed state corresponding to the self shot shooting mode. The deformed state here means a deformed state accompanying rotation of the first housing 2 and the second housing 3.

In FIG. 18, the normal shooting mode is a shooting mode corresponding to a case when shot in a state in which the imaging lens 2a is oriented in substantially the same direction as the direction of a line of sight of the cameraman and the display 3g is oriented toward the cameraman side.

As shown in FIG. 18, a deformed state corresponding to the normal shooting mode can be defined as a state in which the second housing 3 is rotated about 180 degrees in a direction around the vertical axis from the accommodated state and the angle of rotation in a direction around the horizontal axis is within the range of a predetermined angle.

The range of the angle of rotation in a direction around the horizontal axis allowed in the normal shooting mode is in the range of 90 degrees to 180 degrees if the angle of rotation in a direction around the horizontal axis in the accommodated state is assumed to be 0 degree.

By allowing the range of the angle of rotation in a direction around the horizontal axis in the normal shooting mode in such a relatively wide range, a large difference of angle between the direction in which the imaging lens 2a is oriented (imaging direction) and the direction in which the display 3g is oriented can be allowed and the range of shooting angles (from low angles to high angles) that can be supported can be widened. In the normal shooting mode described above, the second housing 3 is suitably gripped as a grip portion for shooting.

In FIG. 19, the stationary shooting mode is a shooting mode corresponding to a case when shot by placing the imaging apparatus 1 using the second housing 3 as a seat portion of the first housing 2. In the stationary shooting mode, the top surface 3u on which the display 3g of the second housing 3 is formed is oriented upward (oriented toward the bottom surface 2d of the first housing 2) to be able to check a captured image.

A deformed state corresponding to the stationary shooting mode can be defined as a state in which the first housing 2 is opened in a direction around the horizontal axis from the accommodated state by an angle equal to a first angle θ1 or more and less than a second angle θ2 (θ1<θ2). This state can be put as a state in which the first housing 2 is rotated upward by a predetermined angle from a state in which “one end” of the first housing 2 and “the other end” of the second housing 3 are oriented in the same direction.

In the deformed state corresponding to the stationary shooting mode, the angle of rotation in a direction around the vertical axis is about 0 degree when the angle of rotation in the accommodated state is assumed to be 0 degree.

In FIG. 20, the self shot shooting mode is a shooting mode corresponding to a case when shot by orienting the imaging lens 2a and the display 3g toward the cameraman side.

A deformed state corresponding to the self shot shooting mode can be defined as a state in which the first housing 2 is opened in a direction around the horizontal axis from the accommodated state by an angle equal to the second angle θ2 or more and equal to or less than a third angle θ3 (θ2<θ3). The third angle θ3 as an upper limit angle in the self shot shooting mode is set to, for example, 90 degrees.

Also in the deformed state corresponding to the self shot shooting mode, the angle of rotation in a direction around the vertical axis is about 0 degree when the angle of rotation in the accommodated state is assumed to be 0 degree.

In the present example, both of moving images and still images can be captured in the normal shooting mode, the stationary shooting mode, and the self shot shooting mode corresponding to the landscape shooting. Shooting of moving images and still images is switched in accordance with an operation.

A still image portrait shooting mode is prepared as a shooting mode corresponding to portrait shooting. In the still image portrait shooting mode, only still image shooting is allowed.

FIG. 21 shows a deformed state of the imaging apparatus 1 corresponding to the still image portrait shooting mode.

A deformed state corresponding to the still image portrait shooting mode can be defined as a state in which the second housing 3 is rotated about 90 degrees in a direction around the horizontal axis from the accommodated state and rotated about 180 degrees in a direction around the vertical axis. In the still image portrait shooting mode, like the normal shooting mode, a case when shot by orienting the imaging lens 2a in substantially the same direction as the direction of the line of sight of the cameraman and the display 3g toward the cameraman side is assumed.

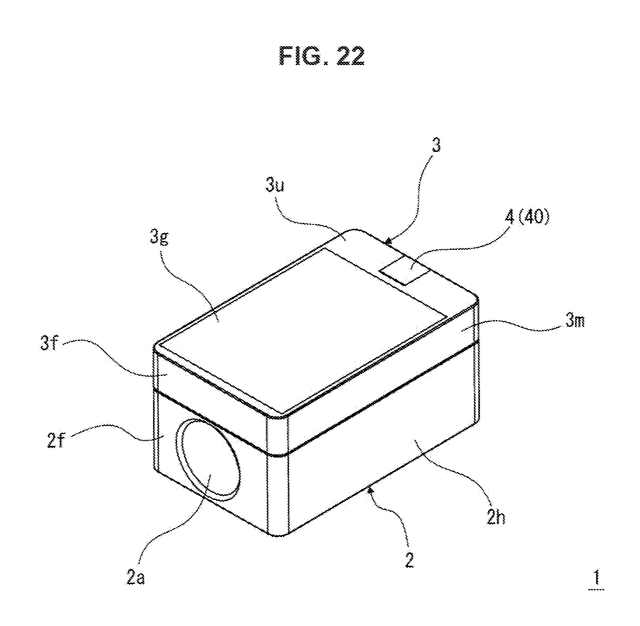

FIG. 22 shows a deformed state of the imaging apparatus 1 corresponding to the playback mode.

A deformed state corresponding to the playback mode can be defined as a state in which the second housing 3 is rotated about 90 degrees in a direction around the vertical axis from the accommodated state and the angle of rotation in a direction around the horizontal axis is the same (about 0 degree) as the angle of the accommodated state.

<3. Internal Configuration of Imaging Apparatus>

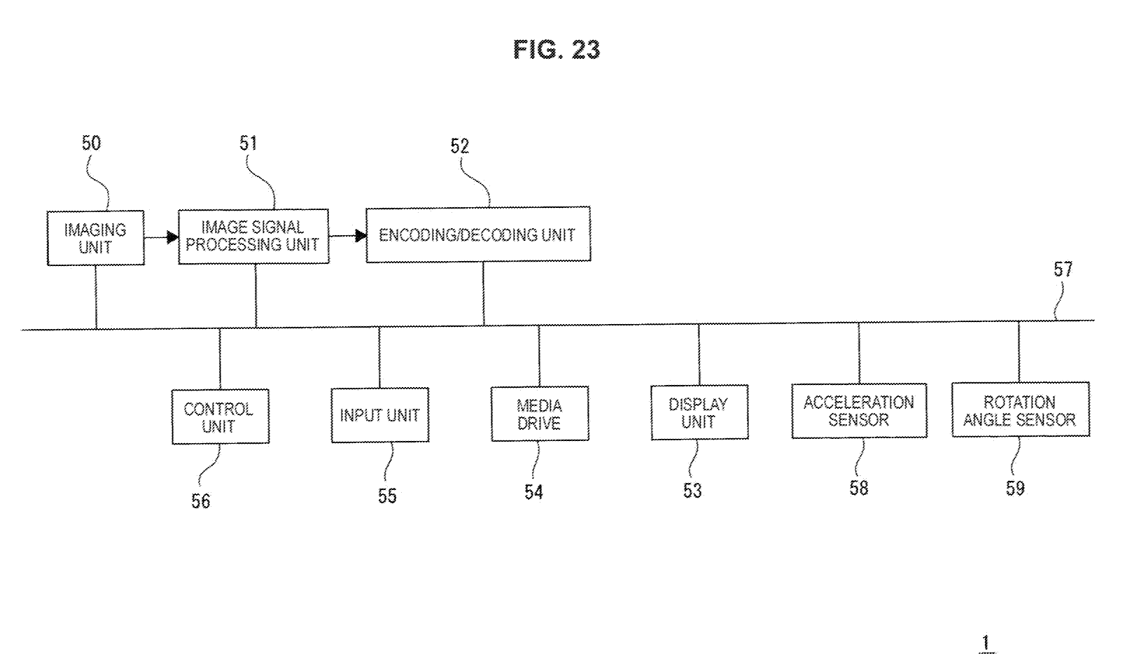

FIG. 23 is a block diagram showing a circuit configuration inside the imaging apparatus 1.

An imaging unit 50, an image signal processing unit 51, an encoding/decoding unit 52, a display unit 53, a medium drive 54, an input unit 55, a control unit 56, a bus 57, an acceleration sensor 58, and a rotation angle sensor 59 are provided inside the imaging apparatus 1. Each unit excluding the bus 57 is mutually connected via the bus 57 to exchange various kinds of data and control signals.

The imaging unit 50 includes a lens unit including the imaging lens 2a, an imaging device, for example, a CCD (Charge Coupled Device) image sensor or a CMOS (Complementary Metal Oxide Semiconductor) image sensor that converts subject light obtained via the lens unit into an electric signal (imaging signal) by photoelectric conversion, a sample hold/AGC (Automatic Gain Control) circuit that performs gain adjustments and wave form shaping of the signal obtained (read) by the imaging device, and a video A/D converter and obtains captured image data as digital data.

The imaging unit 50 has functions to adjust the focal distance (focus), angle of view (zoom), shutter speed, diaphragm and the like based on the control of the control unit 56.

The image signal processing unit 51 performs various kinds of image signal processing on captured image data obtained by the imaging unit 50. For example, tone correction processing, shading correction processing, high-frequency correction (edge correction) processing, and camera shake compensation processing are performed.

The encoding/decoding unit 52 performs compression processing of captured image data on which image signal processing by the image signal processing unit 51 has been performed and decompression processing of compressed captured image data. As the compression/decompression format, compression/decompression processing based on a predetermined still image format, for example, the JPEG (Joint Photographic Experts Group) format is performed for still images and compression/decompression processing based on a predetermined moving image format, for example, the MPEG (Moving Picture Experts Group) format or the AVCHD (Advanced Video Codec High Definition) is performed for moving images and compression/decompression processing based on a predetermined moving image format.

The display unit 53 includes the display 3g and displays various kinds of information based on the control of the control unit 56.

The medium drive 54 is configured by a recording and playback circuit/mechanism for a recording medium such as a semiconductor memory like a flash memory, a magnetic disk, an optical disk, or a magneto-optical disk. The medium drive 54 records various kinds of data such as compressed captured image data in moving image format or still image format obtained by the image compressed processing unit 52 based on the control of the control unit 56 on a recording medium and reads various kinds of data such as compressed captured image data recorded on a recording medium.

The input unit 55 includes operation buttons or the like (not shown) used by the cameraman to do various operation inputs into the imaging apparatus 1 and a touch panel and detects an input operation of the user to communicate information (operation input information) in accordance with the input operation to the control unit 56. In the present example, the input unit 55 includes a touch panel formed in the display 3g.

The acceleration sensor 58 detects gravitational acceleration. In the present example, for example, a three-axis sensor is used as the acceleration sensor 58. The direction in which the gravity acts can be detected based on a DC component of an acceleration detection signal by the acceleration sensor 58 and the vibration can be detected based on an AC component thereof.

The rotation angle sensor 59 detects the rotation angle of the first housing 2 with respect to the vertical axis portion 41v or the vertical axis portion 43 (axis portion 43v) (hereinafter, described as the “angle of rotation in a direction around the vertical axis”) in the aforementioned rotating mechanism and the rotation angle of the second housing 3 with respect to the horizontal axis portion 41h or the horizontal axis portion 44 (hereinafter, described as the “angle of rotation in a direction around the horizontal axis”). In the present example, the rotation angle sensor 59 is set to detect the angle of rotation in a direction around the vertical axis and the angle of rotation in a direction around the horizontal axis by assuming that the angle of rotation in the accommodated state is 0 degree.

The rotation angle sensor 59 has a function of detecting a deformed state of the imaging apparatus 1 accompanying rotation of the first housing 2 and the second housing 3, and the relevant function can also be achieved by other sensors than the rotation angle sensor 59.

The control unit 56 is configured by a microcomputer including, for example, a CPU (Central Processing Unit), a ROM (Read Only Memory), and a RAM (Random Access Memory) and an exercises overall control of the imaging apparatus 1 by performing processing according to a program stored in, for example, the ROM.

For example, when a still image is shot, the control unit 56 exercises control to cause the encoding/decoding unit 52 to perform still image compression processing on captured image data input from the image signal processing unit 51 in accordance with operation input depending on a shutter operation (release operation) via the input unit 55 and to cause the medium drive 54 to record compressed captured image data obtained thereby in a recording medium.

Alternatively, when moving images are shot, the control unit 56 exercises control to cause the encoding/decoding unit 52 to start moving image compression processing on captured image data input from the image signal processing unit 51 in accordance with operation input depending on a recording start operation via the input unit 55 and to cause the medium drive 54 to record compressed captured image data obtained thereby in a recording medium.

The control unit 56 also exercises control to cause the display unit 53 (display 3g) to display an image based on captured image data obtained by the image signal processing unit 51 as a so-called through image in shooting mode.

Further in the present embodiment, the control unit 56 performs processing as described below in accordance with each operation mode described with reference to FIGS. 18 to 22.

<4. Processing in Accordance with Operation Mode>

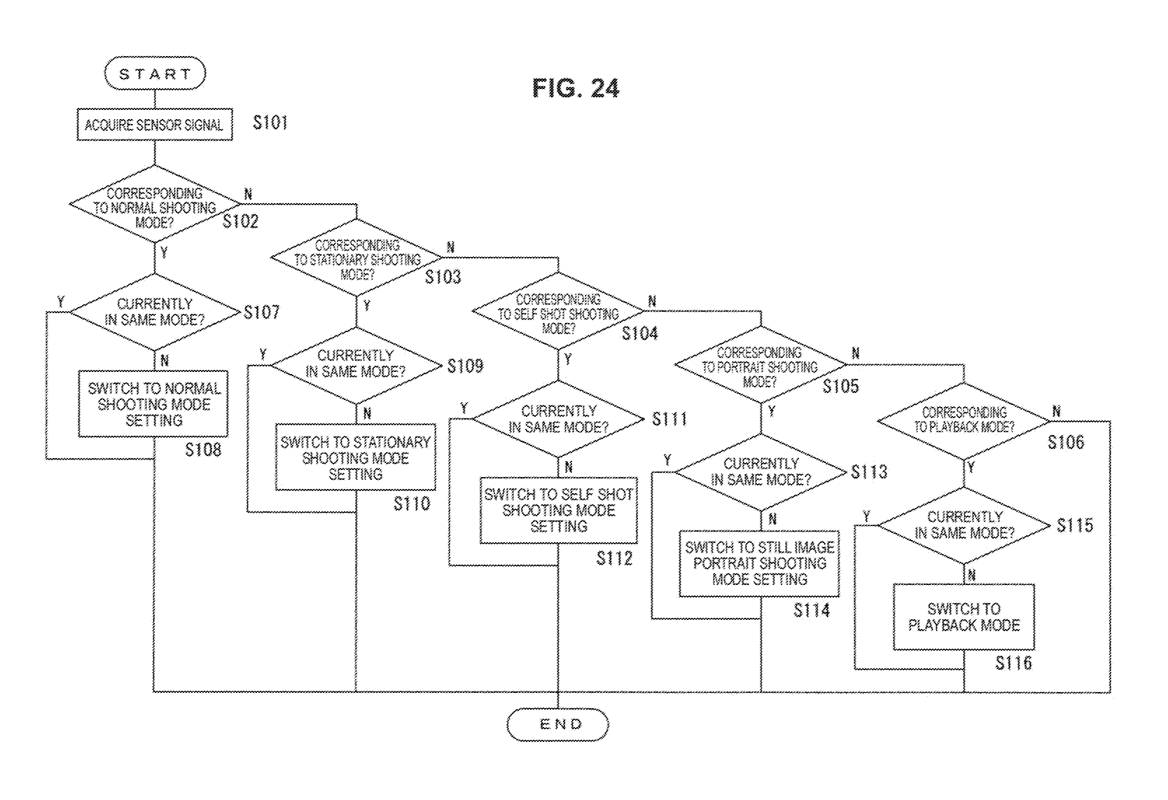

FIG. 24 is an explanatory view of processing performed by the imaging apparatus 1 in accordance with the operation mode.

The processing shown in FIG. 24 is performed by the control unit 56 in accordance with a program stored in, for example, the aforementioned ROM. Also, the processing shown in FIG. 24 is assumed to be processing started, for example, at fixed intervals.

First, as sensor signal acquisition processing in step S101, the control unit 56 acquires a detection signal by the rotation angle sensor 59 and, based on the detection signal, determines whether the current deformed state of the imaging apparatus 1 corresponds to any of the normal shooting mode, the self shot shooting mode, the stationary shooting mode, the still image portrait shooting mode, and the playback mode by processing in steps S102 to S106.

More specifically, the determination processing whether to correspond to the normal shooting mode in step S102 is performed by determining whether conditions of the angle of rotation in a direction around the vertical axis is about 180 degrees and the angle of rotation in a direction around the horizontal axis is in the range of 90 to 180 degrees are satisfied.

The determination processing whether to correspond to the stationary shooting mode in step S103 is performed by determining whether conditions of the angle of rotation in a direction around the vertical axis is about 0 degree and the angle of rotation in a direction around the horizontal axis is in the angle range of the first angle θ1 or more and less than the second angle θ2 are satisfied.

When compared with a case of hand-held shooting, vibrations transmitted to the imaging apparatus 1 are weaker during stationary shooting and thus, a condition of whether the amount of vibration is equal to or less than a predetermined amount (AC component amplitude of a detection signal of the rotation angle sensor 59 is equal to or less than a predetermined value) may be added as a determination condition.

The determination processing whether to correspond to the self shot shooting mode in step S104 is performed by determining whether conditions of the angle of rotation in a direction around the vertical axis is about 0 degree and the angle of rotation in a direction around the horizontal axis is in the angle range of the second angle θ2 or more and the third angle θ3 or less are satisfied.

The determination processing whether to correspond to the still image portrait shooting mode in step S105 is performed by determining whether conditions of the angle of rotation in a direction around the horizontal axis is about 90 degrees and the angle of rotation in a direction around the vertical axis is about 180 degrees are satisfied.

The determination processing whether to correspond to the playback mode in step S106 is performed by determining whether conditions of the angle of rotation in a direction around the vertical axis is about 90 degrees and the angle of rotation in a direction around the horizontal axis is about 0 degree are satisfied.

If none of the operation modes applies, the control unit 56 terminates the processing shown in FIG. 24.

If the deformed state is determined to correspond to the normal shooting mode in step S102, the control unit 56 determines whether the imaging apparatus is currently in the same mode (currently in the normal shooting mode) in step S107, terminates the processing shown in FIG. 24 if the imaging apparatus is in the normal shooting mode, and performs processing to switch to the normal shooting mode in step S108 before terminating the processing shown in FIG. 24 if the imaging apparatus is not in the normal shooting mode.

As the normal shooting mode setting, the control unit 56 exercises control so as to be switched to the following setting. That is, the display 3g is caused to display captured images as through images and images for operation separately. Images for operation here are images in which, for example, various icons for touch operation are arranged in predetermined positions.

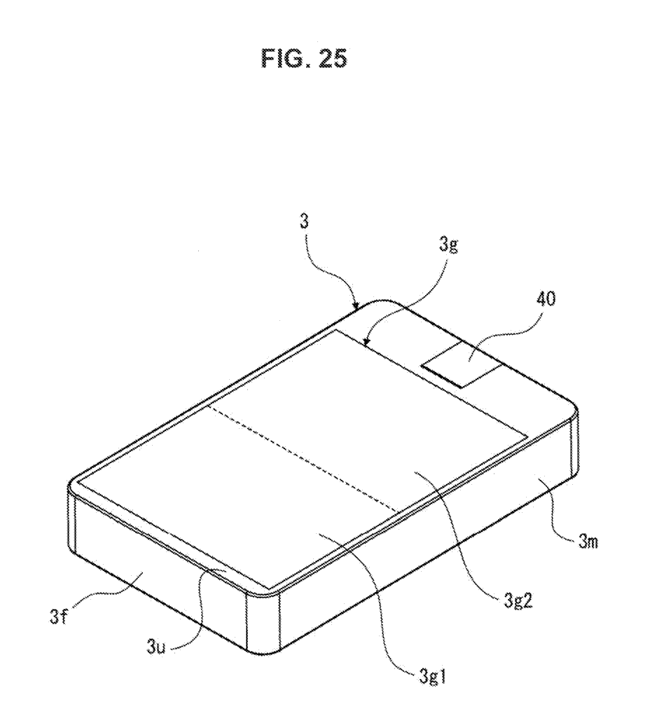

In the present embodiment, as shown in FIG. 25, separate images can be displayed by splitting the display area of the display 3g into a first display area 3g1 and a second display area 3g2. The first display area 3g1 is a display area farther from the linking portion 4 and the second display area 3g2 is a display area closer to the linking portion 4.

In step S108, the control unit 56 exercises control such that through images are displayed in one of the first display area 3g1 and the second display area 3g2 and images for operation are displayed in the other display area.

In this case, a through image is made to display such that the long side and the short side of the first display area 3g1 or the second display area 3g2 and the long side and the short side of the through image match respectively. In other words, compared with a case of the full-screen display on the display 3g, the through image is displayed in the first display area 3g1 or the second display area 3g2 after being rotated by 90 degrees.

As is understood from the above description with reference to FIG. 18, the display 3g is arranged longitudinally when viewed from the cameraman in the normal shooting mode and thus, if a through image is displayed as a full-screen image on the display 3g, the orientation of the image does not match the orientation when viewed from the cameraman, resulting in inconvenience. Therefore, as described above, the through image is made to display such that the long side and the short side of the first display area 3g1 or the second display area 3g2 and the long side and the short side of the through image match respectively.

If only correcting the orientation of image to an appropriate orientation is considered, the above display of the through image may be made in the first display area 3g1 or the second display area 3g2, but if only the through image is displayed, one of the first display area 3g1 and the second display area 3g2 becomes a non-display area, wasting the display area. Therefore, in the present embodiment, as described above, through images and images for operations are displayed separately. Accordingly, the display area of the display 3g can be used more effectively.

As the normal shooting mode setting, the control unit 56 exercises control so that preset normal settings are made as settings related to the imaging operation.

Subsequently, if the deformed state is determined to correspond to the stationary shooting mode in step S103, the control unit 56 determines whether the imaging apparatus is currently in the same mode (currently in the stationary shooting mode) in step S109, terminates the processing shown in FIG. 24 if the imaging apparatus is in the stationary shooting mode, and if the imaging apparatus is not in the stationary shooting mode, performs processing to switch to the stationary shooting mode setting in step S110 and ends the processing shown in FIG. 24.

In step S110, the control unit 56 exercises control such that through images are displayed in the first display area 3g1 and the second display area 3g2 is made a non-display area.

As is evident by referring to FIG. 19, it is difficult for the cameraman to view the second display area 3g2 on the side closer to the linking portion 4 in the stationary shooting mode. Thus, a captured image can be made easier to check by making the second display area 3g2 a non-display area and displaying through images in the first display area 3g1. Also in this case, a through image is displayed by matching the long side and the short side of the through image to the long side and the short side of the first display area 3g1.

In the stationary shooting mode, an image for operation can be considered to be displayed as described below. One method is to display an image for operation by superimposing the image for operation in a through image displayed in the first display area 3g1 in accordance with, for example, a touch operation on the display 3g or a predetermined operation such as holding a hand over the display 3g. Alternatively, displacing a through image from the first display area 3g1 to the second display area 3g2 gradually in accordance with a predetermined operation and displaying an image for operation in a display area made vacant following the displacement or after completion of the displacement can also be considered.

Also in the stationary shooting mode, the camera shake compensation processing can be set to turn off or weaken the effect. Accordingly, power can be saved.

If the deformed state is determined to correspond to the self shot shooting mode in step S104, the control unit 56 determines whether the imaging apparatus is currently in the same mode (currently in the self shot shooting mode) in step S111, terminates the processing shown in FIG. 24 if the imaging apparatus is in the self shot shooting mode, and performs processing to switch to the self shot shooting mode in step S112 if the imaging apparatus is not in the self shot shooting mode, then ends the processing shown FIG. 24.

In step S112, the control unit 56 exercises control such that through images are displayed in one of the first display area 3g1 and the second display area 3g2 and images for operation are displayed in the other display area.

Also in this case, a through image is displayed by matching the long side and the short side of the through image to the long side and the short side of the first display area 3g1 or the second display area 3g2.

In the self shot shooting mode, various settings suitable for self shots can be made. For example, the display area can be caused to display a mirror reversed image as a through image.

A setting to limit the focus adjustable range to a close range side can be made as settings related to the imaging operation (in self shots, the distance from the imaging lens 2a to the cameraman is limited to the length of an arm of the cameraman). This setting can be made for both auto focus and manual focus. A face recognition auto focus setting and a setting of the photometry to centerweighted metering can also be considered.

Further, when zooming is enabled, the angle of view suitable for self shots can automatically be adjusted. If the deformed state is determined to correspond to the self shot shooting in step S104, the control unit 56 determines whether the imaging apparatus is currently in the same mode (currently in the self shot shooting mode) in step S111, terminates the processing shown in FIG. 24 if the imaging apparatus is in the self shot shooting mode, and if the imaging apparatus is not in the self shot shooting mode, performs processing to switch to the self shot shooting mode in step S112 then terminates the processing shown in FIG. 24.

In step S112, the control unit 56 exercises control such that through images are displayed in one of the first display area 3g1 and the second display area 3g2 and images for operation are displayed in the other display area.

Also in this case, a through image is displayed by matching the long side and the short side of the through image to the long side and the short side of the first display area 3g1 or the second display area 3g2.

If the deformed state is determined to correspond to the still image portrait shooting mode in step S105, the control unit 56 determines whether the imaging apparatus is currently in the same mode (currently in the still image portrait shooting mode) in step S 113, if the imaging apparatus is in the still image portrait shooting mode, terminates the processing shown in FIG. 24, and if the imaging apparatus is not in the still image portrait shooting mode, performs processing to switch to the still image portrait shooting mode in step S114 and terminates the processing shown in FIG. 24

In step S114, the control unit 56 exercises control such that through images are displayed in one of the first display area 3g1 and the second display area 3g2 and images for operation are displayed in the other display area.

Also in this case, a through image is displayed by matching the long side and the short side of the through image to the long side and the short side of the first display area 3g1 or the second display area 3g2.

If the deformed state is determined to correspond to the playback mode in step S106, the control unit 56 determines whether the imaging apparatus is currently in the same mode (currently in the playback mode) in step S115, if the imaging apparatus is in the playback mode, terminates the processing shown in FIG. 24, and if the imaging apparatus is not in the playback mode, performs processing to switch to the playback mode in step S116 and terminates the processing shown in FIG. 24.

In the playback mode, the control unit 56 exercises control such that playback images are fully displayed on the display 3g. In the playback mode, the control unit 56 can control the orientation of a playback image displayed on the display 3g based on a result of detecting the posture of the imaging apparatus 1 from a detection signal by the acceleration sensor 58.

A case when the processing shown in FIG. 24 is started at fixed intervals is illustrated above, but the processing shown in FIG. 24 can be started in accordance with a fixed change or more in the deformed state of the imaging apparatus 1.

In addition, a case when the operation mode is switched based on the deformed state of the imaging apparatus 1 for all operation modes is illustrated above, but switching operation mode based on the deformed state is not limited to a case when switching is done for all operation modes and, for example, switching may be done for only one operation mode or a portion of operation modes.

<5. Summary of Embodiment>

The imaging apparatus 1 according to the present embodiment includes, as described above, the first housing 2 at one end of which the imaging lens 2a is mounted, the second housing 3 on which the display 3g is mounted, and the rotating mechanism including the linking portion 4 linking the other end of the first housing 2 and one end of the second housing 3.

Then, the first housing 2 and the second housing 3 are made mutually rotationally movable by the rotating mechanism and the first housing 2 and the second housing 3 are linked by the linking portion 4 in such a way that the one end of the first housing 2 and the other end of the second housing 3 are oriented in the same direction.

Accordingly, the second housing 3 on which the display 3g is mounted can be caused to function as a grip portion to grip the imaging apparatus 1 for shooting or the second housing 3 can be caused to function as a seat portion of the first housing 2 for stationary shooting, increasing shooting styles that can be supported. Therefore, usability of the imaging apparatus 1 can be improved.

The imaging apparatus 1 according to the present also includes the control unit 56 that switches the operation mode based on a deformed state of the imaging apparatus 1 accompanying rotation. Accordingly, an appropriate operation mode in accordance with the form of using the imaging apparatus 1 is set. Therefore, an imaging apparatus whose usability is further improved can be realized.

Further in the imaging apparatus 1 according to the present embodiment, the control unit 56 causes the display 3g to display captured images captured via the imaging lens 2a and images for operation separately. Accordingly, a wasteful non-display area can be prevented from arising on the display 3g. Therefore, the display area of the display 3g can be used more effectively.

Further, in the imaging apparatus 1 according to the present embodiment, the control unit 56 causes the display 3g to display playback images as full-screen images in the playback mode in which images are played back. Accordingly, maximally large playback images are presented. Therefore, the imaging apparatus 1 in which captured images can easily be checked and whose usability is improved can be provided.

In addition, in the imaging apparatus 1 according to the present embodiment, the display 3g is formed on the surface of the second housing 3 directly facing the first housing 2 in a state in which one end of the first housing 2 and the other end of the second housing 3 are oriented in the same direction and the control unit 56 determines whether the imaging apparatus is in a state corresponding to the stationary shooting mode after the first housing 2 being rotated upward by a predetermined angle from the state in which the one end of the first housing 2 and the other end of the second housing 3 are oriented in the same direction based on the deformed state and in accordance with the determination to be a state corresponding to the stationary shooting mode, causes the display area (3g1) on the farther side from the linking portion 4 on the display 3g to display captured images captured via the imaging lens 2a and make the display area (3g2) on the closer side to the linking portion 4 on the display 3g a non-display area. Accordingly, captured images are displayed in the display area on the side on which images can be more easily viewed by the cameraman. Therefore, checking of captured images can be made easier.

Also in the imaging apparatus 1 according to the present embodiment, the whole display 3g is covered with the first housing 2 while the second housing 3 is folded to the side of the first housing 2. Accordingly, the display 3g is not exposed to surroundings in an accommodated state in which the second housing 3 is folded to the side of the first housing 2. Therefore, the display 3g can be protected.

Further, in the imaging apparatus 1 according to the present embodiment, if the direction from one end to the other end of the first housing 2 is the depth direction of the first housing 2, the direction perpendicular to the depth direction of the first housing 2 is the lateral direction of the first housing 2, the direction from one end to the other end of the second housing 3 is the depth direction of the second housing 3, and the direction perpendicular to the depth direction of the second housing 3 is the lateral direction of the second housing 3, the length in the depth direction of the first housing 2 and the length in the depth direction of the second housing 3 are set to be substantially equal and the length in the lateral direction of the first housing 2 and the length in the lateral direction of the second housing 3 are set to be substantially equal.

Accordingly, the external surface of the imaging apparatus 1 can be formed without creating steps while one end of the first housing 2 and the other end of the second housing 3 are oriented in the same direction, that is, the second housing 3 is accommodated. Therefore, the imaging apparatus 1 in which the second housing 3 is accommodated can be made easier to grip and ease with which the imaging apparatus 1 is handled can be improved.

Further, in the imaging apparatus 1 according to the present embodiment, the first housing 2 and the second housing 3 are made mutually rotationally movable by the rotating mechanism in two rotating directions of different rotating axes. Accordingly, the degree of freedom of deformation of the imaging apparatus 1 is increased. Therefore, more shooting styles can be supported and usability can further be improved.

In addition, in the imaging apparatus 1 according to the present embodiment, the linking portion 4 links the first housing 2 and the second housing 3 such that the center axis of rotation becomes displaceable.

Accordingly, there is no need to round the corner on the other end side of the second housing 3 when the first housing 2 and the second housing 3 are made to be mutually rotationally movable. Therefore, constraints in terms of design of the imaging apparatus 1 can be relaxed.

Also, the imaging apparatus 1 according to the present embodiment includes the energizing member (42, 42′) that energizes such that the center of rotation (ah) is displaced in a predetermined direction. Accordingly, the displaced center of rotation is brought back to its original position by the energizing member. Therefore, there is no need to bring back the center of rotation to its original position after the center being displaced, resulting in improved usability.

<6. Modification>

In the foregoing, an embodiment according to the present technology has been described, but the present technology should not be limited to the concrete examples illustrated above.

For example, an imaging apparatus in the present technology can be configured to be able to communicate by wire or wirelessly with an external device such as a smartphone or a tablet terminal directly or via a network.

In this case, the imaging apparatus can also be configured to be able to transfer captured images to an external device or to receive operations from an external device.

An imaging apparatus capable of shooting moving images and still images is illustrated above, but the present technology can be applied to an imaging apparatus capable of shooting at least one of moving images and still images.

Effects described herein are only illustrative and are not to be limited and other effects may also be included.

<7. Present Technology>

Additionally, the present technology may also be configured as below:

(1) An imaging apparatus including:
a first housing at one end of which an imaging lens is mounted;
a second housing on which a display is mounted; and
a rotating mechanism including a linking portion linking another end of the first housing and one end of the second housing,
wherein the first housing and the second housing are made mutually rotationally movable by the rotating mechanism, and
wherein the first housing and the second housing are linked by the linking portion such that the one end of the first housing and another end of the second housing are capable of orienting in a same direction.
(2) The imaging apparatus according to (1), further including:
a control unit that switches an operation mode based on a deformed state of the imaging apparatus accompanying rotation.
(3) The imaging apparatus according to (2),
wherein the control unit causes the display to display captured images captured via the imaging lens and images for operation separately.
(4) The imaging apparatus according to (2) or (3),
wherein the control unit causes the display to display playback images as full-screen images in a playback mode in which images are played back.
(5) The imaging apparatus according to any one of (2) to (4),
wherein the display is formed on a surface of the second housing directly facing the first housing in a state in which the one end of the first housing and the another end of the second housing are oriented in the same direction, and
wherein the control unit
determines whether the imaging apparatus is in a state corresponding to a stationary shooting mode as a state in which the first housing is rotated upward by a predetermined angle from a state in which the one end of the first housing and the another end of the second housing are oriented in the same direction based on the deformed state, and
in accordance with a determination to be the state corresponding to the stationary shooting mode, causes captured images captured via the imaging lens on a display area on a farther side from the linking portion on the display to be displayed, and makes a display area on a closer side to the linking portion on the display a non-display area.
(6) The imaging apparatus according to any one of (1) to (5),
wherein a whole part of the display is covered with the first housing while the second housing is folded to a side of the first housing.
(7) The imaging apparatus according to any one of (1) to (6),
wherein, when a direction from the one end to the another end of the first housing is a depth direction of the first housing, a direction perpendicular to the depth direction of the first housing is a lateral direction of the first housing, a direction from the one end to the another end of the second housing is a depth direction of the second housing, and a direction perpendicular to the depth direction of the second housing is a lateral direction of the second housing,
a length in the depth direction of the first housing and a length in the depth direction of the second housing are made substantially equal, and
a length in the lateral direction of the first housing and a length in the lateral direction of the second housing are made substantially equal.
(8) The imaging apparatus according to any one of (1) to (7),
wherein the first housing and the second housing are made mutually rotationally movable by the rotating mechanism in two rotating directions of different rotating axes.
(9) The imaging apparatus according to any one of (1) to (8),
wherein the linking portion links the first housing and the second housing such that a center axis of rotation is displaceable.
(10) The imaging apparatus according to (9), further including:
an energizing member that energizes such that a center of the rotation is displaced in a predetermined direction.

What is claimed is:

1. An imaging apparatus comprising:
a first housing at one end of which an imaging lens is mounted;
a second housing on which a display is mounted; and
a rotating mechanism including a linking portion linking another end of the first housing and one end of the second housing,
wherein the first housing and the second housing are made mutually rotationally movable by the rotating mechanism, and
wherein the first housing and the second housing are linked by the linking portion such that the one end of the first housing and another end of the second housing are capable of orienting in a same direction.

2. The imaging apparatus according to claim 1, further comprising:
a control unit that switches an operation mode based on a deformed state of the imaging apparatus accompanying rotation.

3. The imaging apparatus according to claim 2,
wherein the control unit causes the display to display captured images captured via the imaging lens and images for operation separately.

4. The imaging apparatus according to claim 2,
wherein the control unit causes the display to display playback images as full-screen images in a playback mode in which images are played back.

5. The imaging apparatus according to claim 2,
wherein the display is formed on a surface of the second housing directly facing the first housing in a state in which the one end of the first housing and the another end of the second housing are oriented in the same direction, and
wherein the control unit
determines whether the imaging apparatus is in a state corresponding to a stationary shooting mode as a state in which the first housing is rotated upward by a predetermined angle from a state in which the one end of the first housing and the another end of the second housing are oriented in the same direction based on the deformed state, and
in accordance with a determination to be the state corresponding to the stationary shooting mode, causes captured images captured via the imaging lens on a display area on a farther side from the linking portion on the display to be displayed, and makes a display area on a closer side to the linking portion on the display a non-display area.

6. The imaging apparatus according to claim 1,
wherein a whole part of the display is covered with the first housing while the second housing is folded to a side of the first housing.

7. The imaging apparatus according to claim 1,
wherein, when a direction from the one end to the another end of the first housing is a depth direction of the first housing, a direction perpendicular to the depth direction of the first housing is a lateral direction of the first housing, a direction from the one end to the another end of the second housing is a depth direction of the second housing, and a direction perpendicular to the depth direction of the second housing is a lateral direction of the second housing,
a length in the depth direction of the first housing and a length in the depth direction of the second housing are made substantially equal, and
a length in the lateral direction of the first housing and a length in the lateral direction of the second housing are made substantially equal.

8. The imaging apparatus according to claim 1,
wherein the first housing and the second housing are made mutually rotationally movable by the rotating mechanism in two rotating directions of different rotating axes.

9. The imaging apparatus according to claim 1,
wherein the linking portion links the first housing and the second housing such that a center axis of rotation is displaceable.

10. The imaging apparatus according to claim 9, further comprising:
an energizing member that energizes such that a center of the rotation is displaced in a predetermined direction.
